(19) United States
(12) Patent Application Publication
(10) Pub. No.: US 2007/0067842 A1
(43) Pub. Date: Mar. 22, 2007

(54) Systems and methods for collecting files related to malware

(76) Inventors: Michael P. Greene, Boulder, CO (US); Paul L. Piccard, Longmont, CO (US)

Correspondence Address: COOLEY GODWARD KRONISH LLP;ATTN: PATENT GROUP, THE BOWEN BUILDING, 875 15TH STREET, N.W. SUITE 800, WASHINGTON, DC, 20005-2221, US

(21) Appl. No.: 11/199,468

(22) Filed: Aug. 8, 2005

(51) Int. Cl. G06F 12/14

(52) U.S. Cl. 726/24

(57) ABSTRACT

Systems and methods for collecting files related to malware are described. In one embodiment, a system includes a malware detection module configured to analyze a set of files of a protected computer to determine that a first file of the set of files is related to potential malware. The system also includes a malware reporting module configured to selectively transfer the first file to a host computer.

### FIELD OF THE INVENTION

The invention relates generally to computer system management. In particular, but not by way of limitation, the invention relates to systems and methods for collecting files related to malware.

### BACKGROUND OF THE INVENTION

Personal computers and business computers can be vulnerable to attack by computer programs such as keyloggers, system monitors, browser hijackers, dialers, Trojans, spyware, and adware, which are collectively referred to as “malware” or “pestware.” Malware typically operates to collect information about a person or an organization—often without the person's or the organization's knowledge. In some instances, malware also operates to report information that is collected about a person or an organization. Some malware is highly malicious. Other malware is non-malicious but may nevertheless raise concerns with privacy or computer system performance. And yet other malware is actually desired by a user.

Techniques are currently available to detect and remove malware. But as malware evolves, techniques for detecting and removing malware should also evolve. Current techniques for detecting and removing malware are not always satisfactory and will likely not be satisfactory in the future. In particular, current techniques for detecting and removing malware often use definitions of known malware to scan files of a protected computer. However, it is often difficult to initially collect malware in order to generate definitions, particularly since malware can evolve. It would be desirable to accelerate and simplify a process of collecting malware, such that definitions can be rapidly generated or updated to account for new or evolving malware. Accordingly, systems and methods are needed to address the shortfalls of current techniques and to provide other new and innovative features.

### SUMMARY OF THE INVENTION

Embodiments of the invention include systems of managing malware. In one embodiment, a system includes a malware detection module configured to analyze a set of files of a protected computer to determine that a first file of the set of files is related to potential malware. The system also includes a malware reporting module configured to selectively transfer the first file to a host computer.

Embodiments of the invention also include computer-readable media. In one embodiment, a computer-readable medium includes executable instructions to compare a first file of a protected computer with a set of definitions of known malware. The computer-readable medium also includes executable instructions to, responsive to determining that the first file sufficiently matches at least one of the set of definitions, direct the protected computer to transfer a content of the first file to a host computer.

Embodiments of the invention further include computer-implemented methods of managing malware. In one embodiment, a computer-implemented method includes detecting a presence of potential malware on a protected computer. The computer-implemented method also includes determining that a first file of a set of files of the protected computer is related to the potential malware. The computer-implemented method further includes reporting a content of the first file to a host computer, such that the content of the first file can be used to generate a definition of the potential malware.

Other embodiments of the invention are also contemplated. The foregoing summary and the following detailed description are not meant to restrict the invention to any particular embodiment but are merely meant to describe some embodiments of the invention.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates a computer system that is implemented in accordance with an embodiment of the invention.

FIG. 2 illustrates a flowchart for collecting files related to malware, according to an embodiment of the invention.

### DETAILED DESCRIPTION

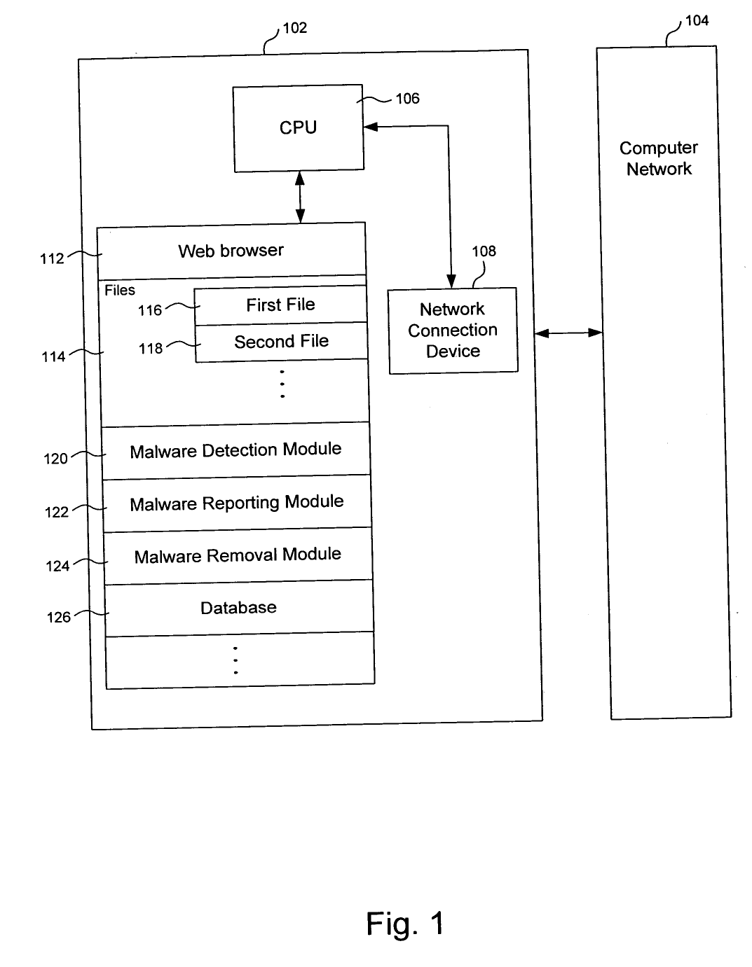

FIG. 1 illustrates a computer system 100 that is implemented in accordance with an embodiment of the invention. The computer system 100 includes at least one protected computer 102, which is connected to a computer network 104 via any wire or wireless transmission channel. In general, the protected computer 102 can be a client computer, a server computer, or any other device with data processing capability. Thus, for example, the protected computer 102 can be a desktop computer, a laptop computer, a handheld computer, a tablet computer, a personal digital assistant, a cellular telephone, a firewall, or a Web server. In the illustrated embodiment, the protected computer 102 is a client computer and includes conventional client computer components, including a Central Processing Unit (“CPU”) 106 that is connected to a network connection device 108 and a memory 110.

As illustrated in FIG. 1, the memory 110 stores a number of computer programs, including a Web browser 112. The Web browser 112 operates to establish communications with the computer network 104 via the network connection device 108. In particular, the Web browser 112 is operated by a user who visits various Web sites that are included in the computer network 104.

Referring to FIG. 1, the memory 110 also stores a number of files 114, including a first file 116 and a second file 118. One or more of the files 114 may have been downloaded from the computer network 104 using the Web browser 112. It is also contemplated that one or more of the files 114 may have been downloaded from other sources that are external to the protected computer 102 or may have been locally generated by the protected computer 102. Examples of the files 114 include Web pages, data files, text files, documents, spreadsheets, image files, audio files, Musical Instrument Digital Interface (“MIDI”) files, video files, multimedia files, batch files, history logs, registry files, files including computer programs, and various other types of executable or non-executable files.

As illustrated in FIG. 1, the memory 110 also stores a set of computer programs that implement the operations described herein. In particular, the memory 110 stores a malware detection module 120, a malware reporting module 122, and a malware removal module 124. As further described below, the various modules 120, 122, and 124 operate to manage malware that can be present in the computer system 100. Referring to FIG. 1, the various modules 120, 122, and 124 operate in conjunction with a database 126, which includes information related to malware. In particular, the database 126 includes a set of definitions to allow for detection of malware. The database 126 can be implemented as, for example, a relational database in which information is organized using a set of tables.

In the illustrated embodiment, the malware detection module 120 and the malware reporting module 122 operate to facilitate collection of files that are related to malware. Referring to FIG. 1, the malware detection module 120 monitors the protected computer 102 on a periodic or some other basis to determine that the protected computer 102 includes potential malware. Detection of the potential malware on the protected computer 102 can be based on, for example, the set of definitions that are included in the database 126. In connection with detecting the potential malware, the malware detection module 120 determines which of the files 114 are related to the potential malware. For example, the malware detection module 120 can determine that either, or both, of the first file 116 and the second file 118 is related to the potential malware.

Once the malware detection module 120 determines which of the files 114 are related to the potential malware, the malware reporting module 122 reports information related to those files to a remotely-located host computer that is included in the computer network 104. In particular, the malware reporting module 122 directs the protected computer 102 to selectively transfer those files to the host computer via the network connection device 108. In such manner, contents of those files as well as any additional relevant information can be analyzed at the host computer to determine whether the potential malware is, in fact, malware.

As illustrated in FIG. 1, the malware removal module 124 operates to remove files that are related to malware. In particular, once the malware detection module 120 determines which of the files 114 are related to the potential malware, the malware removal module 124 removes those files from the protected computer 102. It is also contemplated that the malware removal module 124 can quarantine those files pending confirmation of whether the potential malware is, in fact, malware.

Advantageously, the illustrated embodiment improves the efficiency at which files related to malware can be collected, thus allowing definitions to be rapidly generated or updated to account for new or evolving malware. In particular, since the computer system 100 can include additional protected computers that are implemented in a similar fashion as the protected computer 102, certain efficiencies of the illustrated embodiment follow from its decentralized nature. In addition, the illustrated embodiment allows automated collection of relevant files once potential malware is detected, thus facilitating targeted analysis of those files. As a result, files that are not related to malware can be omitted from analysis, while files that are related to malware or are potentially related to malware can be targeted for analysis.

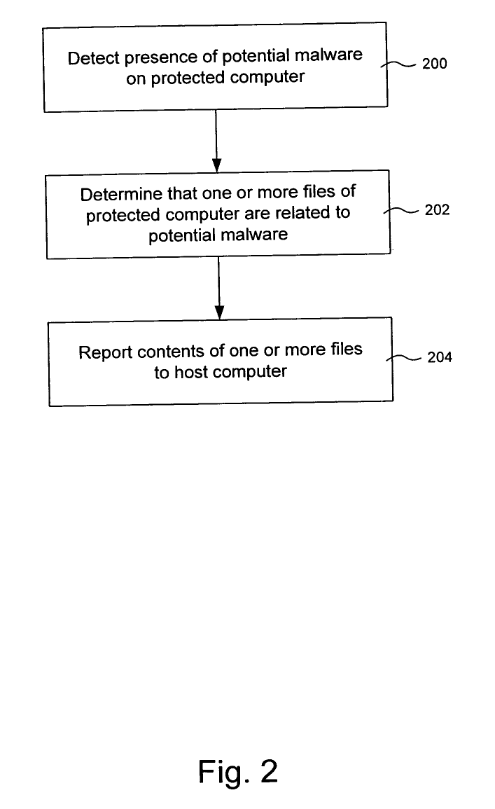

The foregoing provides a general overview of an embodiment of the invention. Attention next turns to FIG. 2, which illustrates a flowchart for collecting files related to malware, according to an embodiment of the invention.

The first operation illustrated in FIG. 2 is to detect a presence of potential malware on a protected computer (e.g., the protected computer 102) (block 200). In the illustrated embodiment, a malware detection module (e.g., the malware detection module 120) detects the presence of the potential malware by monitoring the protected computer on a periodic or some other basis. It is also contemplated that operation of the malware detection module can be triggered based on a particular event, such as in response to a file being downloaded using a Web browser (e.g., the Web browser 112).

In the illustrated embodiment, the malware detection module detects the presence of the potential malware based on a set of definitions of malware. In particular, the set of definitions can include representations of known malware, and the malware detection module can scan files (e.g., the files 114) of the protected computer to detect the potential malware in one or more of the files. For example, the set of definitions can include a set of hash values or digital signatures of known malware, such as those generated using Message Digest 5 (“MD5”). In this example, the malware detection module can generate a hash value of a particular file to be analyzed, and can compare the hash value of that file with the set of hash values of the known malware to determine whether there is a sufficient match. As can be appreciated, MD5 is a type of hash function that generates a string of numbers of fixed length from a particular file. MD5 is sometimes referred to as being “one-way,” since operation of this type of hash function can be substantially irreversible. As another example, the set of definitions can include a set of Cyclical Redundancy Codes (“CRCs”) of portions of known malware. In this example, the malware detection module can generate a CRC of a particular file to be analyzed, and can compare the CRC of that file with the set of CRCs of the known malware to determine whether there is a sufficient match.

Alternatively, or in conjunction, the set of definitions can include suspicious activities that are indicative of or that are common to known malware, and the malware detection module can monitor activities of the protected computer to detect the presence of the potential malware on the protected computer. For example, the set of definitions can include suspicious activities related to third party cookies or related to entries or modifications of registry files of an operating system. As another example, the set of definitions can include suspicious activities related to reporting of information to third parties or related to modifications of Web browser settings. As a further example, the set of definitions can include suspicious activities related to operation of watcher programs. As can be appreciated, a watcher program can monitor malware so as to restart the malware, possibly under a new name, when the malware is terminated. Similarly, when the watcher program is terminated, the malware can restart the watcher program.

The second operation illustrated in FIG. 2 is to determine that one or more files of the protected computer are related to the potential malware (block 202). In the illustrated embodiment, in connection with detecting the potential malware on the protected computer, the malware detection module determines which files of the protected computer are related to the potential malware. In such manner, the malware detection module can facilitate targeted collection of relevant files, which, in turn, can accelerate and simplify analysis of those files to determine whether the potential malware is, in fact, malware. Further acceleration and simplification can be achieved by filtering out duplicative files, such as when the same version of a file has been previously collected, or by filtering out files that are downloaded from approved Web sites.

In the illustrated embodiment, the malware detection module determines which files are related to the potential malware based on the set of definitions of malware. For example, in connection with scanning files of the protected computer, the malware detection module can analyze the files to determine that a first file (e.g., the first file 116) includes the potential malware. In some instances, the malware detection module can determine that multiple files are related to the potential malware. For example, the malware detection module can analyze files of the protected computer to determine that the first file and a second file (e.g., the second file 118) include the same portion or different portions of the potential malware. As another example, the malware detection module can analyze files of the protected computer to determine that the first file includes the potential malware while the second file includes a potential watcher program that is restarting the potential malware.

Alternatively, or in conjunction, the malware detection module can determine which files are related to the potential malware by analyzing a set of processes related to the potential malware, which set of processes can sometimes be referred to as a “process tree.” In particular, in connection with detecting the potential malware on the protected computer, the malware detection module can identify a process tree related to the potential malware. By traversing along the process tree, the malware detection module can determine which files are operated upon by the potential malware as well as which files are operating in conjunction with the potential malware. For example, once the malware detection module determines that the first file includes the potential malware, the malware detection module can traverse along a process tree to determine that the second file includes entries or modifications related to operation of the potential malware.

The third operation illustrated in FIG. 2 is to report contents of the one or more files to a remotely-located host computer that is connected to the protected computer (block 204). In the illustrated embodiment, once the malware detection module determines which files are related to the potential malware, a malware reporting module (e.g., the malware reporting module 122) reports information related to those files to the host computer. Desirably, this information includes all or substantially all contents of those files. It is also contemplated that this information can identify those files as being related to the potential malware, such as in terms of names of those files. It is further contemplated that this information can identify suspicious activities related to the potential malware. This information as well as any additional relevant information can be analyzed at the host computer to determine whether the potential malware is, in fact, malware. In the event that the potential malware is malware that is unknown or has since evolved, the host computer or a user at the host computer can generate or update a definition of the malware, and this definition can be provided to the protected computer.

To facilitate communication with the host computer, the malware reporting module can compress information that is reported to the host computer. Compression can be performed in accordance with any of various data compression techniques, including those that are dictionary-based and those that are statistical in nature. For a similar reason as discussed above as well as to provide enhanced privacy, the malware reporting module can encrypt information that is reported to the host computer. Encryption can be performed in accordance with any of various cryptographic techniques, including those based on secret keys and those based on public keys. Compression and encryption are sometimes referred to as being “two-way,” since their operation can be substantially reversible. Thus, for example, once the host computer receives information that has been compressed and encrypted, the host computer can recover original contents by decrypting and decompressing the received information.

In the illustrated embodiment, the malware reporting module also alerts a user of the protected computer about the potential malware. In particular, once the malware detection module determines which files of the protected computer are related to the potential malware, the malware reporting module alerts the user accordingly. In addition, if the user subsequently attempts to download one of those files, such as from a Web site, the malware reporting module again alerts the user. It is also contemplated that the malware reporting module can alert the user about the potential malware pending confirmation of whether the potential malware is, in fact, malware.

It should be recognized that the embodiments of the invention described above are provided by way of example, and various other embodiments are contemplated. For example, with reference to FIG. 1, while the various modules 120, 122, and 124 and the database 126 are illustrated as included in the protected computer 102, it should be recognized that such configuration is not required in all implementations. In particular, it is contemplated that one or more of the various modules 120, 122, and 124 and the database 126 can be included in a separate computer that is connected to the protected computer 102. Thus, for example, one or more of the various modules 120, 122, and 124 and the database 126 can be included in the host computer that is included in the computer network 104.

An embodiment of the invention relates to a computer program product with a computer-readable medium including computer code or executable instructions thereon for performing a set of computer-implemented operations. The medium and computer code can be those specially designed and constructed for the purposes of the invention, or they can be of the kind well known and available to those having ordinary skill in the computer software arts. Examples of computer-readable media include: magnetic media such as hard disks, floppy disks, and magnetic tape; optical media such as Compact Disc-Read Only Memories (“CD-ROMs”) and holographic devices; magneto-optical media such as floptical disks; and hardware devices that are specially configured to store and execute computer code, such as Application-Specific Integrated Circuits (“ASICs”), Programmable Logic Devices (“PLDs”), Read Only Memory (“ROM”) devices, and Random Access Memory (“RAM”) devices. Examples of computer code include machine code, such as generated by a compiler, and files including higher-level code that are executed by a computer using an interpreter. For example, an embodiment of the invention can be implemented using Java, C++, or other object-oriented programming language and development tools. Additional examples of computer code include encrypted code and compressed code. Moreover, an embodiment of the invention can be downloaded as a computer program product, which can be transferred from a remotely-located computer to a protected computer by way of data signals embodied in a carrier wave or other propagation medium via a transmission channel. Accordingly, as used herein, a carrier wave can be regarded as a computer-readable medium.

Another embodiment of the invention can be implemented using hardwired circuitry in place of, or in conjunction with, computer code. For example, with reference to FIG. 1, the various modules 120, 122, and 124 can be implemented using computer code, hardwired circuitry, or a combination thereof.

While the invention has been described with reference to some embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit and scope of the invention. All such modifications are intended to be within the scope of the claims appended hereto. In particular, while the methods described herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

What is claimed is:

1. A computer-implemented method of managing malware, comprising:
detecting a presence of potential malware on a protected computer;
determining that a first file of a set of files of the protected computer is related to the potential malware; and
reporting a content of the first file to a host computer, such that the content of the first file can be used to generate a definition of the potential malware.

2. The computer-implemented method of claim 1, wherein the detecting the presence of the potential malware includes scanning the set of files based on a set of hash values of known malware.

3. The computer-implemented method of claim 1, wherein the detecting the presence of the potential malware includes monitoring the protected computer for activity that is indicative of the presence of the potential malware.

4. The computer-implemented method of claim 1, wherein the determining that the first file is related to the potential malware includes determining that the first file includes the potential malware.

5. The computer-implemented method of claim 1, wherein the reporting the content of the first file includes compressing the content of the first file.

6. The computer-implemented method of claim 1, wherein the reporting the content of the first file includes encrypting the content of the first file.

7. The computer-implemented method of claim 1, further comprising:
determining that a second file of the set of files is related to the potential malware; and
reporting a content of the second file to the host computer.

8. The computer-implemented method of claim 7, wherein the determining that the second file is related to the potential malware includes determining that the second file includes a potential watcher program related to the potential malware.

9. A computer-readable medium comprising executable instructions to:
compare a first file of a protected computer with a set of definitions of known malware; and
responsive to determining that the first file sufficiently matches at least one of the set of definitions, direct the protected computer to transfer a content of the first file to a host computer.

10. The computer-readable medium of claim 9, wherein the executable instructions to compare the first file with the set of definitions include executable instructions to compare a hash value of the first file with a set of hash values of the known malware.

11. The computer-readable medium of claim 9, wherein the executable instructions to direct the protected computer to transfer the content of the first file include executable instructions to at least one of compress and encrypt the content of the first file.

12. The computer-readable medium of claim 9, further comprising executable instructions to:
compare a second file of the protected computer with the set of definitions; and
responsive to determining that the second file sufficiently matches at least one of the set of definitions, direct the protected computer to transfer a content of the second file to the host computer.

13. A system of managing malware, comprising:
a malware detection module configured to analyze a set of files of a protected computer to determine that a first file of the set of files is related to potential malware; and
a malware reporting module configured to selectively transfer the first file to a host computer.

14. The system of claim 13, wherein the malware detection module is configured to analyze the set of files based on a set of definitions of known malware.

15. The system of claim 13, wherein the malware reporting module is configured to selectively transfer a content of the first file to the host computer.

16. The system of claim 15, wherein the malware reporting module is configured to at least one of compress and encrypt the content of the first file.

17. The system of claim 13, wherein the malware detection module is configured to analyze the set of files to determine that a second file of the set of files is related to the potential malware, and the malware reporting module is configured to selectively transfer the second file to the host computer.
